(19) United States
(12) Patent Application Publication
(10) Pub. No.: US 2007/0033994 A1
(43) Pub. Date: Feb. 15, 2007

(54) Dynamometer with flexible closed loop torque transmitting element

(76) Inventor: Severino D'Angelo, Laguna Beach, CA (US)

Correspondence Address: HARNESS, DICKEY & PIERCE, P.L.C., P.O. BOX 828, BLOOMFIELD HILLS, MI, 48303, US

(21) Appl. No.: 11/201,077

(22) Filed: Aug. 10, 2005

(51) Int. Cl. G01M 15/00

(52) U.S. Cl. 73/117

(57) ABSTRACT

A chassis dynamometer for loading a driven wheel of a vehicle. The dynamometer includes a frame defining a main axis, a tensioner and a flexible closed-loop torque transmitting element. An input member is arranged along an axis that is generally perpendicular to the main axis. The tensioner is configured to frictionally engage the flexible closed-loop torque transmitting element to the driven wheel so that the flexible closed-loop torque transmitting element transmits power between the driven wheel and the input member. A related method is also provided.

### INTRODUCTION

The present invention generally relates to chassis dynamometers for loading a motor vehicle with one or more drive wheels and more particularly to a compact, low-profile chassis dynamometer and related method.

Vehicle dynamometers are primarily used for two purposes: as measuring devices for determining the torque and/or horsepower output of the vehicle, and as loading and power generating devices for simulating the forces to which a vehicle is normally subjected during actual operation of the vehicle including forces produced by the engine and vehicle brakes. The forces simulated include inertial forces, which are a function of the vehicle's weight and which must be overcome for the vehicle to accelerate or decelerate, “road load” forces, which are those which must be overcome to maintain vehicle speed, and include such factors as break-away torque, rolling friction and windage.

Dynamometers typically include a roll or a pair of rolls for engaging the driven wheel (e.g., motorcycle) or wheels (e.g., automobile) of the vehicle being tested. The roll or rolls are supported by a shaft or shafts journaled in bearings mounted on a frame.

Typically, a power absorber, such as a friction brake, an eddy current brake, hydrokinetic brake or an electric motor is coupled to the roll for absorbing power from the roll which, in turn, applies a retarding force to the surface of the vehicle wheel to simulate the road load forces. Generally, the inertial forces are simulated by coupling the roll to one or more mechanical flywheels. The combined inertia of the flywheels and the roll (as well as the absorber) exert force on the vehicle wheels proportional to the acceleration (or deceleration) of the vehicle wheels.

In applications requiring large power transfer between the vehicle wheels and the dynamometer rolls, one drawback to the known dynamometer configurations concerns their overall size. In high volume automotive assembly plants, such dynamometers may be installed in a relatively large pit so that only a portion of the roller or rollers extends above grade. The use of a pit, however, is often times undesirable in situations where the dynamometer is located in a leased facility or where the dynamometer is moved on a frequent basis (e.g., employed by the mechanics associated with a professional racing team). In such situations it is not uncommon for the dynamometer to be installed at grade level. Given that the roller or rollers can be several feet in diameter, a hoist system is typically employed to raise the vehicle to a level off the ground where its drive wheel or wheels contact the top of the roller or rollers. Given that the vehicle may be tested at full throttle, an extensive array of safety restraints are typically employed to secure the vehicle to the walls of the building in which the dynamometer is located.

While this system is effective, it will be readily apparent to the reader that several drawbacks are inherent. For example, the relatively large size of the dynamometer, hoist and restraint system will typically consume all of the floor space in a given service bay. Since this equipment is used together typically on an infrequent basis, this equipment consumes valuable floor space in a relatively unproductive manner. Moreover, the need for raising the vehicle and for restraining the elevated vehicle during the test greatly increases the time associated with setting up the test equipment at a given location and also with setting up the vehicle to conduct a test.

Accordingly, there remains a need in the art for a more portable and compact dynamometer.

### SUMMARY

In one form, the present teachings provide a method that includes: providing an apparatus having a frame and a device selected from a group consisting of power absorbers, power generators and combinations thereof, the frame having a main axis, the device having a shaft member that is generally perpendicular to the main axis; mounting a wheel relative to the apparatus such that the wheel is rotatable about a wheel axis that is generally parallel to the axis of the shaft member; coupling the shaft member and the wheel with a flexible closed-loop torque transmitting element; and transferring energy between a perimeter of the wheel and the shaft member via the flexible closed-loop torque transmitting element.

In another form, the present teachings provide a method that includes: providing a dynamometer with a pair of rollers and a power absorber having an input member; placing a driven wheel onto the rollers such that a perimeter of the driven wheel contacts an outer surface of each of the rollers, the driven wheel having a diameter that is larger than two times a diameter of either of the pair of rollers; coupling the input member and the driven wheel with a flexible closed-loop torque transmitting element; and transferring energy from the driven wheel to the input member through a flexible closed-loop torque transmitting element.

In yet another form, the present teachings provide a dynamometer for loading a driven wheel of a vehicle. The dynamometer includes a frame that defines a main axis, means for supporting a driven wheel relative to the frame, an apparatus selected from at least one of a power absorber, a power generator and a flywheel, a tensioner and a flexible closed-loop torque transmitting element. The apparatus having a shaft member that is arranged along an axis that is generally perpendicular to the main axis. The flexible closed-loop torque transmitting element being engaged by the tensioner and configured to frictionally engage the wheel. The flexible closed-loop torque transmitting element transmitting power between the shaft member and the wheel.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a side elevation view of a dynamometer constructed in accordance with the teachings of the present invention;

FIG. 2 is a top plan view of the dynamometer of FIG. 1; and

FIG. 3 is a top plan view similar to that of FIG. 2 but illustrating a brake tester constructed in accordance with the teachings of the present invention.

### DETAILED DESCRIPTION OF THE VARIOUS EMBODIMENTS

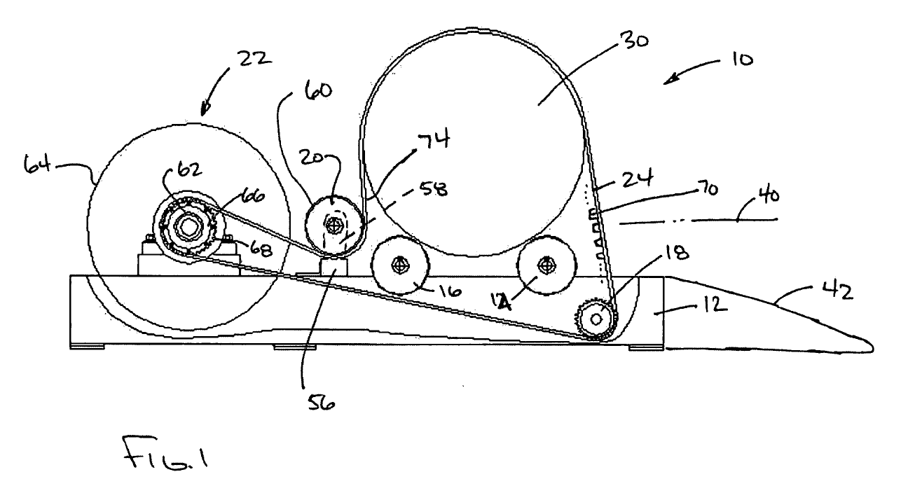

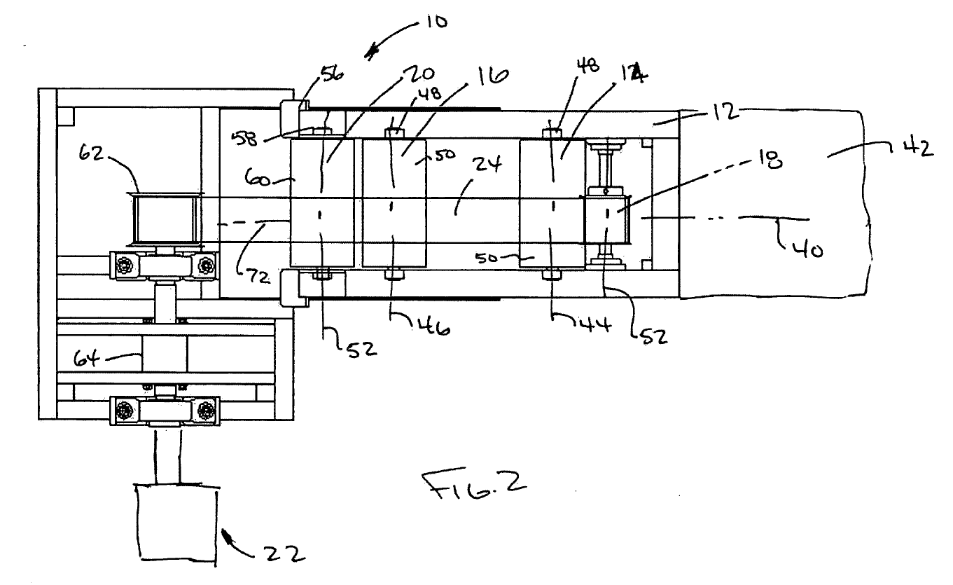

With reference to FIGS. 1 and 2 of the drawings, a dynamometer constructed in accordance with the teachings of the present invention is generally indicated by reference numeral 10. The dynamometer 10 can include a frame 12, a first roller 14, a second roller 16, an idler wheel 18, a tensioner 20, a power absorber 22 and a flexible closed-loop torque transmitting element 24. While the dynamometer 10 is illustrated and described herein in reference to a single driven wheel 30, those of ordinary skill in the art will appreciate that the frame 12 and/or first and second rollers 14 and 16, as appropriate may be extended or that a second dynamometer, which can be a mirror image but otherwise identical to the arrangement illustrated, can be employed to facilitate the testing of a vehicle with a pair of driven wheels. The driven wheel 30 can be conventionally constructed in a manner that is so well known in the art as to not require further discussion. Briefly, the driven wheel 30 can include a wheel or hub member onto which an inflatable tire may be mounted. It will be appreciated that multiple dynamotors 10 may be employed to test a vehicle having multiple drive wheels. For example four of the dynamometers 10 may be employed to facilitate the testing of a vehicle with four driven wheels.

The frame 12 can define a main axis 40 that those of ordinary skill in the art will appreciate as being an axis along which a vehicle (only the driven wheel 30 of which is shown) may be inserted to the dynamometer 10. The configuration of the frame 12 that is illustrated is merely exemplary and it will be appreciated that the first and second rollers 14 and 16, the tensioner 20, the idler wheel 18 and the power absorber 22 can be coupled to or mounted on the frame 12. Optionally, the frame 12 can include a ramp member 42 that permits the driven wheel 30 of the vehicle to be rolled up from grade level onto the first and second rollers 14 and 16 as illustrated in FIG. 1.

The first and second rollers 14 and 16 can be rotatably coupled to the frame 12 along respective roller axes 44 and 46, respectively, that can be generally transverse to the main axis 40 of the frame 12 and spaced apart from one another along the main axis 40. The first and second rollers 14 and 16 can be formed with a diameter that is less than about one-half a diameter of the driven wheel 30 to thereby reduce the overall height at which the first and second rollers 14 and 16 are disposed above grade level. In the particular example provided, the first and second rollers 14 and 16 are identically configured, having a roller shaft 48 that is supported on the frame 12 by a first pair of bearings (not specifically shown) and a roller member 50, that is supported on the roller shaft 48 by a second pair of bearings (not specifically shown).

The idler wheel 18, like the first and second rollers 14 and 16, can be rotatably coupled to the frame 12 about an idler wheel axis 52 that can be generally transverse to the main axis 40. In the example provided, the idler wheel 18 is mounted to the frame 12 forwardly of the first roller 14.

The tensioner 20 can be any appropriate type of tensioner and in the example provided, is an automotive self-adjusting style tensioner having a tensioner base 56, which can be fixedly but removably coupled to the frame 12, a tensioner arm 58 and a tensioner wheel 60. The tensioner arm 58 can be pivotally coupled to the tensioner base 56 and can be biased by a spring (not specifically shown) in a rotational direction toward the second roller 16. The tensioner wheel 60 can be rotatably mounted to the tensioner arm 58.

The power absorber 22 can have an input member 62 and can be selected from a group of power absorbers consisting of friction brakes, eddy current brakes, hydrokinetic brakes and electric motors. Such power absorbers are well known in the art and need not be discussed in significant detail herein. Regardless of the particular power absorber used, the power absorber 22 can have a flywheel 64 that can be coupled for rotation with the input member 62. In the particular example provided, the input member 62 includes a shaft coupling 66 having a plurality of transversely extending teeth members 68 that are formed about the circumference of the shaft coupling 66.

The flexible closed-loop torque transmitting element 24 can be a cable, a chain or a belt, for example, and is employed to frictionally engage at least a portion of the circumference of the driven wheel 30 and the input member 62 to transmit power therebetween. In the particular example provided, the flexible closed-loop torque transmitting element 24 is a belt having a plurality of teeth 68 formed on an interior side thereof. The teeth 70 are oriented generally transverse to a longitudinal axis 72 of the belt and engage the teeth members 68 that are formed on the shaft coupling 66. The tensioner wheel 60 is urged into a loop portion 74 that is formed in the belt to thereby frictionally engage the belt to both the portion of the circumference of the driven wheel 30 and the input member 62. It will be appreciated that corresponding teeth may also be formed on the exterior of the idler wheel 18.

To employ the dynamometer 10, a technician may roll the driven wheel 30 of the vehicle up the ramp member 42 and onto the first and second rollers 14 and 16. In this orientation, the driven wheel 30 is rotatable about a wheel axis 80 that is generally parallel to the roller axes 44 and 46. The flexible closed-loop torque transmitting element 24 may be placed about the idler wheel 18, the shaft coupling 66 and between the tensioner wheel 60 and the driven wheel 30. The tensioner 20 may be adjusted so that the tensioner is rotated or moved away from the driven wheel 30 so that the flexible closed-loop torque transmitting element 24 may be wrapped about a portion of the circumference of both the idler wheel 18 and the driven wheel 30. Thereafter, the idler wheel 18 is moved in a direction that frictionally engages the flexible closed-loop torque transmitting element 24 into frictional engagement with the driven wheel 30. It will be apparent to those of ordinary skill in the art that the tensioner 20 tensions the flexible closed-loop torque transmitting element 24 so that slack is removed from the flexible closed-loop torque transmitting element 24 and power may be transmitted through the flexible closed-loop torque transmitting element 24 between the driven wheel 30 and the input member 62.

While the dynamometer 10 has been illustrated and described as including a pair of rollers 14 and 16, those of ordinary skill in the art will appreciate from this disclosure that the dynamometer 10 may be configured somewhat differently. For example, a single roller may be employed in lieu of the pair of rollers 14 and 16. Also alternatively, the dynamometer may not utilize any rollers but rather may utilize a lift system (e.g., one or more jacks or a vehicle lift) to elevate the vehicle such that the driven wheel or wheels are located off the ground. Regardless of the quantity of rollers that are used, the flexible closed-loop torque transmitting element 24 may be employed to connect the driven wheel 30 to the input member 62 in the manner that is described above.

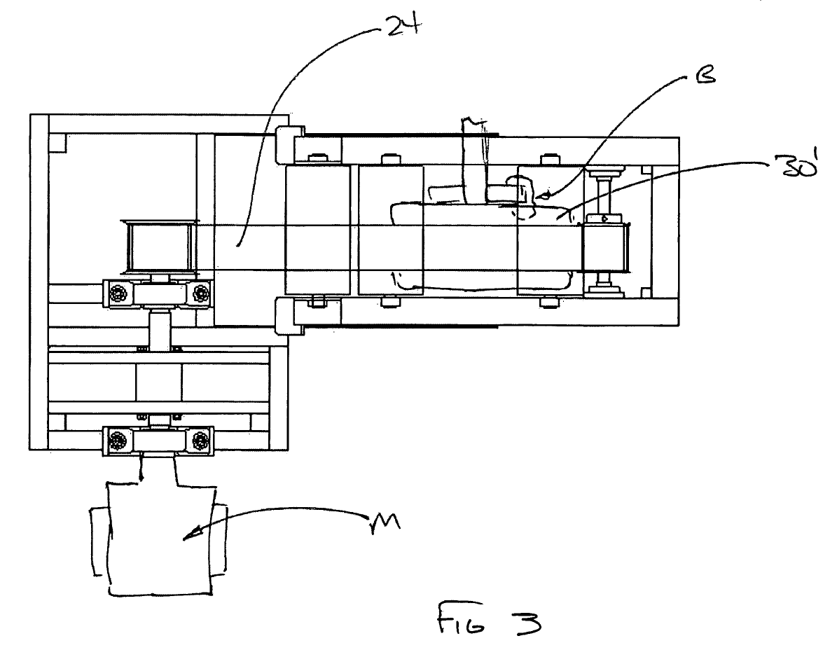

It will also be appreciated that although the present invention has been described in conjunction with a dynamometer, the teachings of the present invention have somewhat broader applicability. In this regard, the teachings of the present invention have particular applicability in devices for testing power loading and in devices for performing a brake test. In the latter category of devices, a power generator (e.g., electric motor M) can be substituted for the power absorber 22 and can be employed to provide rotary power that is transmitted to the wheel 30′ via the flexible closed-loop torque transmitting element 24 as shown in FIG. 3. The brake test device 10′ can be employed to drive the wheel 30′ to test the performance of a wheel braking system B that is associated with the wheel 30′. Alternatively, the dynamometer may be configured without a power absorber or power generator per se, but could simply employ a rotating mass, such as a flywheel that is coupled to a shaft that is in turn coupled to the flexible closed-loop torque transmitting element 24.

While the invention has been described in the specification and illustrated in the drawings with reference to various embodiments, it will be understood by those of ordinary skill in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A method comprising:
providing an apparatus having a frame and a device selected from a group consisting of power absorbers, power generators, flywheels and combinations thereof, the frame having a main axis, the device having a shaft member that is generally perpendicular to the main axis;
mounting a wheel relative to the apparatus such that the wheel is rotatable about a wheel axis that is generally parallel to the axis of the shaft member;
coupling the shaft member and the wheel with a flexible closed-loop torque transmitting element; and
transferring energy between the wheel and the shaft member via the flexible closed-loop torque transmitting element.

2. The method of claim 1, wherein the flexible closed-loop torque transmitting element is a belt.

3. The method of claim 2, wherein a plurality of teeth are provided on an interior side of the belt and wherein each of the teeth is oriented generally transverse to a longitudinal axis of the belt.

4. The method of claim 1, wherein coupling the shaft member and the wheel comprises:
wrapping the flexible closed-loop torque transmitting element about a portion of a circumference of the wheel; and
tensioning the flexible closed-loop torque transmitting element to frictionally engage the flexible closed-loop torque transmitting element to the portion of the circumference of the wheel.

5. The method of claim 4, wherein the apparatus further includes a tensioner having a spring-biased tensioner arm and a tensioner roller that is rotatably mounted on the tensioner arm.

6. The method of claim 1, wherein the portion of the circumference of the wheel extends is greater than or equal to one-third of the circumference of the wheel.

7. The method of claim 1, wherein the power absorber is selected from a group of power absorbers consisting of friction brakes, eddy current brakes, hydrokinetic brakes and electric motors.

8. The method of claim 7, wherein a flywheel is coupled for rotation with the shaft member.

9. A method comprising:
providing a dynamometer with a pair of rollers and a power absorber having an input member;
placing a driven wheel onto the rollers such that a perimeter of the driven wheel contacts an outer surface of each of the rollers, the driven wheel having a diameter that is larger than two times a diameter of either of the pair of rollers;
coupling the input member and the driven wheel with a flexible closed-loop torque transmitting element; and
transferring energy from the driven wheel to the input member through a flexible closed-loop torque transmitting element.

10. The method of claim 9, wherein coupling the input member and the driven wheel comprises:
wrapping the flexible closed-loop torque transmitting element about a portion of a circumference of the driven wheel; and
tensioning the flexible closed-loop torque transmitting element to frictionally engage the flexible closed-loop torque transmitting element to the portion of the circumference of the driven wheel.

11. The method of claim 10, wherein the portion of the circumference of the driven wheel extends is greater than or equal to one-third of the circumference of the driven wheel.

12. The method of claim 11, wherein the flexible closed-loop torque transmitting element is a belt.

13. The method of claim 11, wherein the power absorber is selected from a group of power absorbers consisting of friction brakes, eddy current brakes, hydrokinetic brakes and electric motors.

14. The method of claim 13, wherein a flywheel is coupled for rotation with the input member.

15. The method of claim 14, wherein the flexible closed-loop torque transmitting element is a belt.

16. An apparatus comprising:
a frame defining a main axis;
means for supporting a wheel relative to the frame;
a power absorber or a power generator having a shaft member, the shaft member being arranged along an axis that is generally perpendicular to the main axis;
a tensioner; and
a flexible closed-loop torque transmitting element that is urged by the tensioner into frictional engagement with a perimeter of the wheel to thereby permit the flexible closed-loop torque transmitting element to transmit power between the wheel and the shaft member.

17. The apparatus of claim 16, wherein the supporting means includes at least one roller.

18. The apparatus of claim 17, wherein the supporting means includes a pair of rollers and wherein the rollers have a diameter that is less than one-half a diameter of the wheel.

19. The apparatus of claim 16, wherein the power absorber is selected from a group of power absorbers consisting of friction brakes, eddy current brakes, hydrokinetic brakes and electric motors.

20. The apparatus of claim 19, wherein a flywheel is coupled for rotation with the shaft member.

21. The apparatus of claim 16, wherein the flexible closed-loop torque transmitting element is a belt.

22. A method comprising:
providing an apparatus having a frame and a device selected from a group consisting of power generators, power absorbers, rotating masses, and combination power generator/absorbers, the device having a rotating shaft member, the frame defining a main axis;
mounting a wheel relative to the frame such that a rotational axis of the wheel is perpendicular to the main axis;
coupling the rotating shaft member and the wheel to one another via a flexible closed-loop torque transmitting element that is disposed about a perimeter of the wheel; and
transferring energy between the wheel and the rotating shaft member via the flexible closed-loop torque transmitting element.
